(19) United States
(12) Patent Application Publication
(10) Pub. No.: US 2014/0326538 A1
(43) Pub. Date: Nov. 6, 2014

(54) REMOVABLE LADDER STEP

(71) Applicant: Abid Ali Najey, Brossard (CA)

(72) Inventor: Abid Ali Najey, Brossard (CA)

(21) Appl. No.: 14/207,887

(22) Filed: Mar. 13, 2014

(30) Foreign Application Priority Data
May 6, 2013 (CA) 2815004

(51) Int. Cl. E06C 7/08

(52) U.S. Cl. CPC E06C 7/08
USPC 182/129

(57) ABSTRACT

A removable step mountable to a rung ladder having first and second side rails. The step comprises a platform provided with first and second side supports at opposite ends thereof. The first support has a first stop member at a first end adapted to engage a first end of a rung, and abutment means projecting outwardly from a second end of the support to abut on a frontal face of the first side rail. Symmetrically, the second side support has a first stop member at a first end adapted to engage a second end of the rung, and abutment means projecting outwardly from a second end of said support to abut on a frontal face of the second side rail. The step is mountable to the ladder in a working position by engaging the stop members about the rung and causing the abutment means to abut on the front faces of the first and second side rails respectively. A system is further provided, comprising a removable ladder step for providing additional foot support to a rung ladder and ladder step mounting means attachable to a part of a ladder body and adapted to removably attach said ladder step thereto.

### BACKGROUND

I. Field of Invention

The invention pertains to ladder attachments. More specifically, the invention pertains to a removable ladder step mountable to a rung ladder for providing additional foot support. The invention is further concerned with mounting means for attaching said step to a ladder body when not in use. The mounting means may comprise a bracket firmly connectable to a ladder's side rail by means of fasteners.

The ladder step is well known in industrial history. Different materials were used to produce ladder steps in various configurations to serve the same, equivalent or similar purpose, which is to provide an additional foot support area. The previous inventions have failed to combine the required features below in one single removable ladder step, making the ladder step performance quite unsatisfactory.
A removable ladder step should meet the following objects and features: Wide enough to support a user's feet in order to provide a comfortable and correct (ergonomic) body posture while working; Stable and rigid for safety purposes;
Adjustable, to accommodate various erecting angles and different ladder types; and
Readily applicable and removable from working position, and readily mountable to a ladder body through mounting means;
Attachable to a ladder body when not in use, so as to provide hand free during a ladder handling or climbing;
Accessible by a user involved in performing activities in an elevated level above the ground;
Light in weight and small in size for easy handling and positioning.
Economic;

II. Description of the Prior Art

Various ladder step devices were invented in U.S. and Canada:

In patent CA 587,050 to Carl Babits, the step has a pair of arms to engage the side rails; the invention is applicable only to a circular-section rung, whereas the present disclosure accommodates various rung configurations.

In U.S. Pat. No. 6,966,406 to Edward Lee Nash, the invention can only be used with a hollow rung ladder with open ends. The device extends wider than a ladder's side rails, a valuable horizontal area extending between the side rails was ignored, this area typically forms a part of the tread surface area. An adjustable side plate mechanism is used to accommodate various ladder widths. The support rod adopted to abut the side rail surfaces has a span extending beyond the side rails. This is not preferable, as a longer span considerably increases the bending moment applied on the rod.

In comparison, the present disclosure is directed towards nearly all ladder types. The device is attachable to the ladder body when not in use, and mountable to a rung between the side rails. Engaging pins or a continuous abutment rod are used to accommodate various ladder widths. The span of the abutment rod subjected to the bending moment is shorter than the platform length, with said platform adapted to be received between side rails.

Patent CA 2,028,158 to Nowlan, comprises a vertical supporting member to secure the platform to a pair of rungs.

Patent CA 1,176,610 Stecklow combines a supporting platform with a telescopically adjustable stabilizer.

U.S. Pat. No. 4,482,030 to Lincourt is for a safety platform with L-shape hooks used for attachment to the upper and lower rungs.

U.S. Pat. No. 1,920,552 to Dollerhide shows a detachable ladder step secured to two rungs of a ladder; U-shape hooks are used for securing the ladder step to the upper rung.

U.S. Pat. No. 3,511,338 to Chapman utilizes a U-shape bracket to secure the device to a lower rung and steel hooks to secure the stand to a upper rung.

U.S. Pat. No. 2,500,559 to Miller is directed to a ladder platform wherein a base is pivotally secured to one rung, with swinging hook means are adjustable to various positions, by means of notched formations in side flanges of the platform.

U.S. Pat. No3,294,197 to Kwiatkowski discloses a perch for a ladder that sits upon one rung and has a cross member which engages vertical support arms.

U.S. Pat. No. 4,646,878 to Moyer discloses a portable ladder step with a portable attachment means and having a leveling means connected to the attachment and the platform.

U.S. Pat. No. 4,401,187 to Van Patten discloses a ladder platform accessory using resilient bracket arms in a hinged connection to the platform.

U.S. Pat. No. 4,211,307 to Ethridge discloses a removable step for a ladder which permits the shelf or platform to be pivoted inward and outward so as not to obstruct normal use.

U.S. Pat. No. 3,067,836 to Carnicelli is directed to an adjustable step for ladders utilizing two side members which contact the ladder rungs.

U.S. Pat. No. 2,297,883 to Glover, U.S. Pat. No. 2,282,133 to Horton, U.S. Pat. No. 4,687,075 to Skaggs and U.S. Pat. No. 1,725,723 to Silva are variations of the Carnicelli type of construction.

U.S. Pat. No. 1,216,214 to Connell is also analogous to the construction type of Carnicelli.

U.S. Pat. No. 4,909,351 to Johnson, discloses a platform attachment for a ladder with both a retracted and a working position.

None of these inventions, whether taken singly or in combination, disclose or suggest the specific details of the present invention as claimed. They all present limitations and drawbacks with respect to the need for a safe and fully functional removable ladder step attachment.

Therefore, an object of the present invention is to provide a novel, lightweight and compact removable ladder step, which can be attached to a ladder body when not in use, making it easily accessible for mounting in place by those users required to remain on a ladder for an extended period of time, such as communication company technicians. An additional object of the invention is to provide a device that can be easily removed, handled and locked in place by using one hand. A further object of the invention is to accommodate various rung-type ladders, and to provide adjustable, safe, rigid, and substantially stable step support.

### SUMMARY

There is disclosed a removable ladder step, mountable to a rung-ladder to provide an additional foot support area. The device can be attached to a ladder body when not in use, and can be easily accessed by a user. In the present invention, a vertically applied load is transferred from a platform to side supports to be simultaneously supported by a supporting rung and the side rails of a ladder.

There is thus provided ladder step removably mountable for providing additional foot support to a rung ladder having first and second side rails and rungs extending therebetween. The ladder step comprises a platform provided with first and second side supports at opposite sides thereof. The first side support has a first stop member at a first end thereof adapted to engage a first end of a rung, and an abutment means projecting outwardly from a second end of said first side support to abut on a frontal face of said first side member. Symmetrically, the second side support has a second stop member at a first end thereof adapted to engage a second end of the rung and an abutment means projecting outwardly from a second end of said second side support to abut on a frontal face of said second side rail. Spacing between the first and the second stop members being shorter than the length of supporting rung. Thereby, the ladder step is mountable to the ladder in a working position by engaging the stop members about the rung and causing the abutment means to abut on the front faces of the first and second side rails respectively.

In an embodiment, the platform may further comprise a plate-like member and stiffening wall projecting from an underside thereof.

In an embodiment, stop members may comprise rung engaging hooks.

In an embodiment, abutment means may comprise engaging pins or an engaging rod.

In an embodiment, side supports may further comprise a support leg defining a side face provided with a plurality of apertures for selectively and slidably receiving the abutment means for adjustability of an abutment position of the abutment means on the side rails front faces.

According to another aspect, there is further provided a ladder step system mountable to a rung ladder having rungs and side rails defining a ladder body. The system comprises a ladder step for providing additional foot support to the rung ladder and ladder step mounting means attachable to a part of the ladder body and adapted to removably attach said ladder step thereto for storing the ladder step when not in use.

In specific embodiments, the mounting means may comprise mounting brackets fixedly attachable to a side rail of the ladder. The mounting bracket may have connecting means for engaging the side rails, a step-receiving means adapted to form a space for receiving the step therein and locking means for preventing the removable step from being accidentally dislodged.

In operation, the removable step can be readily released from the mounting means and installed on the ladder in a working position. A user is able to release the removable step by using one hand, while climbing up the ladder. A removable step mounted to a mounting bracket can be released by pushing and holding the step in a direction parallel to the side rail axis, with its lower end being rotated outwardly away from the step-receiving configuration to disengage the locking means. The user can continue climbing up to the targeted elevation to secure the step onto a corresponding rung by engaging the stop members thereto. The step can then be simply locked in working position by urging the abutment means toward the adjacent side rails.

According to an aspect, the removable step can be leveled in a generally horizontal position by removing engaging pins or engaging rod from receiving apertures, and properly positioning the platform. The user can then reinsert the engaging means into the corresponding apertures that are nearest to the side rails.

### BRIEF DESCRIPTION OF THE DRAWINGS

In the drawings, which form a part of this specification:

FIG. 1 is a perspective view of the removable ladder step according to an embodiment thereof, as it would be deployed on an extension ladder leaning against support.

FIG. 2 is a perspective view of the removable ladder step of FIG. 1, when not in use, attached to mounting means.

FIG. 3 is a perspective view showing the removable ladder step from viewpoint above the step.

FIG. 4 is a perspective view showing the removable ladder step from viewpoint below the step.

FIG. 5 is a top plan view of the removable ladder step showing the location of vertical cross sections of views 6, and 7.

FIG. 6 is a front view of the removable ladder step taken on line 6-6, showing the relationship between the platform and the side supports.

FIG. 7 is a transverse cross section view taken on line 7-7, showing the relationship between the platform and the side supports.

FIG. 8 is a perspective view showing a platform of the removable ladder step.

FIG. 9 is a top plan view of the platform showing the location of cross sectional view 10.

FIG. 10 is a transverse cross sectional view taken on line 10-10.

FIG. 11 is a perspective view showing the side supports and the location of vertical cross sectional views 12 and 13.

FIG. 12 is a side view taken on line 12-12 showing details of a side support of the ladder step engaging a ladder rung.

FIG. 13 is a front view of the removable ladder step taken on line 13-13, showing side support details.

FIG. 14 is a perspective view showing the side supports mounted to a rung.

FIG. 15 is a perspective view showing amounting bracket of a step mounting means according to an embodiment in association with a removable ladder step when not in use, the view is enlarged twice.

FIG. 16 is a perspective view showing the mounting bracket; the view is enlarged twice.

FIG. 17 is a top plan view showing the mounting bracket connected to a ladder side rail and the location of vertical sections 18 and 19.

FIG. 18 is a side view taken on line 18-18, showing the mounting bracket details in association with a ladder side rail, the view is enlarged twice.

FIG. 19 is a cross sectional view taken on line 19-19, showing the mounting bracket details in association with a ladder side rail; the view is enlarged twice.

FIG. 20 is a side view showing the stages for mounting a removable ladder step to mounting bracket.

FIG. 21 is a front view of an embodiment of the removable ladder step, showing a continuous slidable rod as the abutment means.

### DETAILED DESCRIPTION

The present invention is to be used as a foot support step, capable of providing additional supporting area. The device can also be used as flat surface platform to hold tools or the like.

Although the present invention will be essentially described in association with the extension ladder, it should be understood that it is also applicable to other rung-type ladders. The removable ladder step will by described in the following by means of embodiments thereof for illustrative purpose only and should not be limited thereto but only by the global spirit of the invention as expressed by the claims.

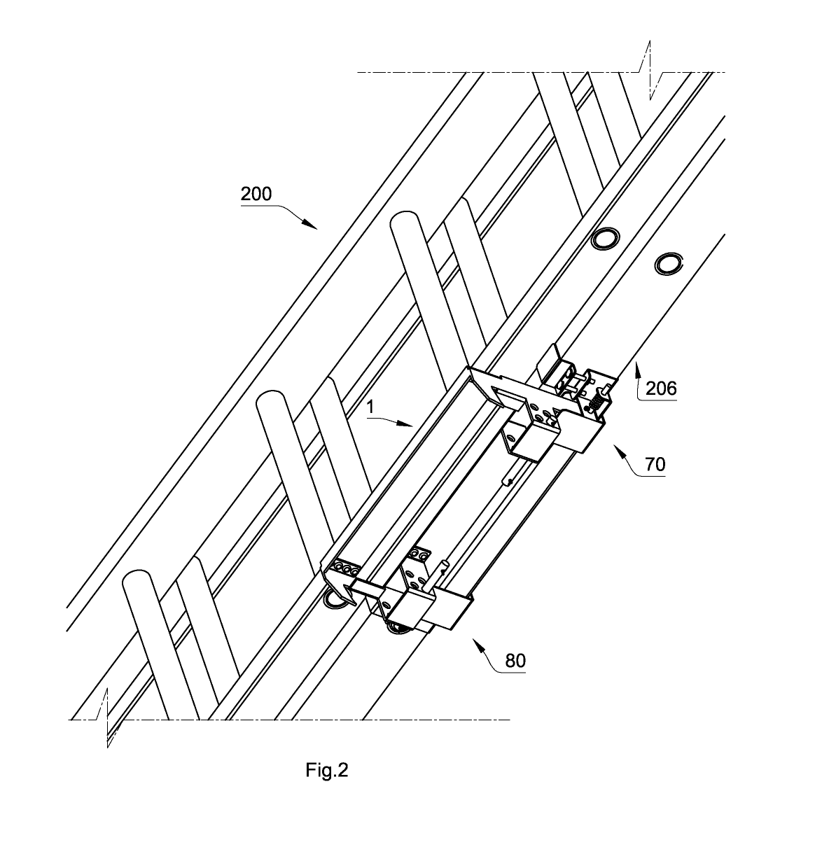

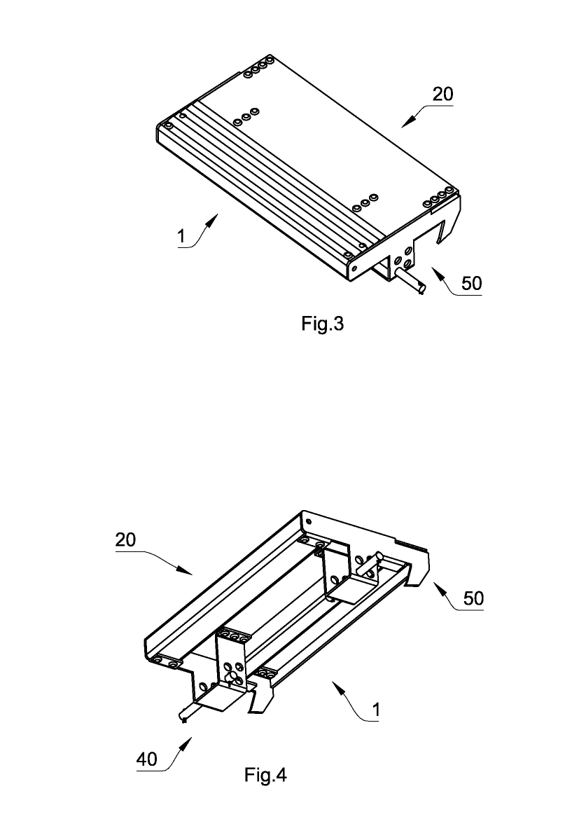

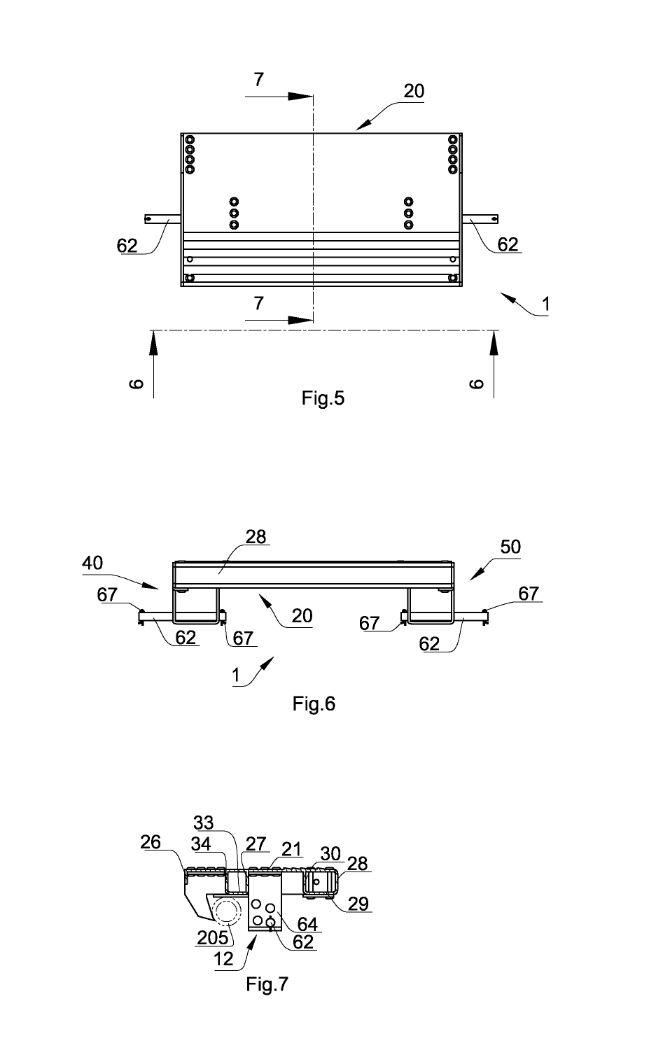

With reference to the drawings of this invention, the removable ladder step of this invention is generally designated by the numeral 1, the mounting means is designated by the numeral 10, which includes two separate complementary and co-operating parts: first mounting bracket 70 and second mounting bracket 80 (FIG. 2).

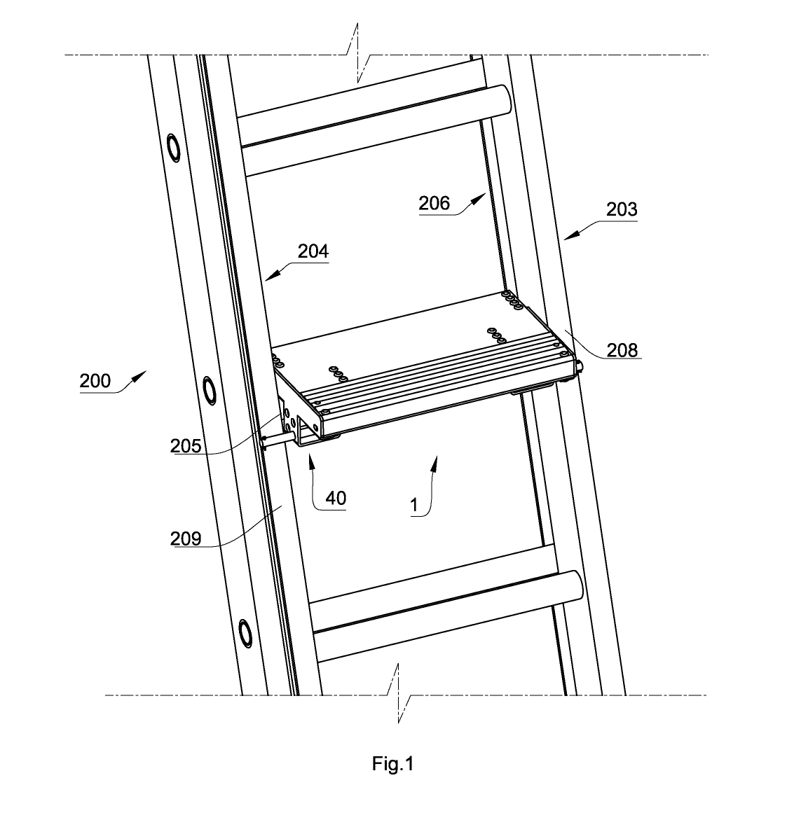

In FIG. 1 a typical extension ladder 200 is shown in the conventional slanted position that a ladder would assume when positioned upon a supporting wall. Step 1 is shown ready to use, sitting on a supporting rung 205 and side rails 203 and 204, forming a horizontal supporting platform ready to support a load. The step 1 basically comprises a platform 20 extending between rails 203 and 204, side supports 40 and 50 and abutment means 62. FIG. 2 illustrates step 1 when not in use, attached to the extension ladder 200 by mounting bracket 10, which is fixedly connected to side rail 206.

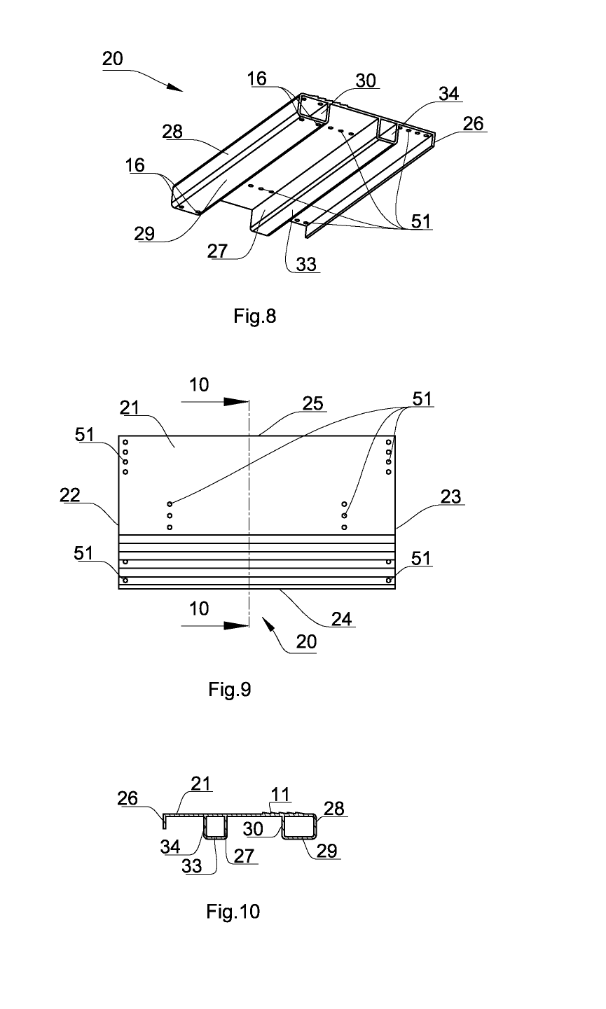

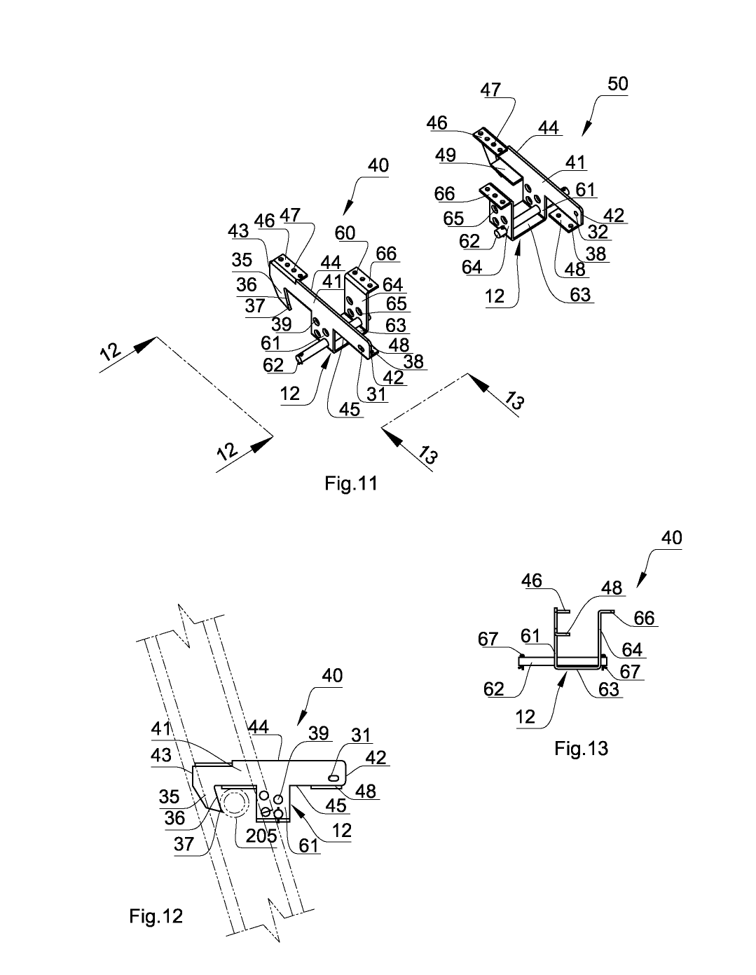

Platform 20 extends between side rails 203 and 204, best appears in FIGS. 8-10, It has a plate-like member 21 defining a first short side 22, a second short side 23, a front long side 24 and a rear long side 25 (FIG. 9). Plate-like member 21 upper surface adjacent to front long side 24 is provided with corrugated configuration 11 (FIG. 10) to achieve the highest friction possible in the contact area between a user's shoe and the said surface. Plate-like member 21 includes a plurality of apertures 51, adapted to connect platform 20 to the side supports 40 and 50 (FIG. 11) by means of fasteners such as rivets.

Plate-like member 21 has a straight bent that projecting downwardly from the rear long side 25, perpendicular to the plate-like member 21 to form a wall 26 (FIG. 8). Wall 26 extends longitudinally between the first short side 22 and second short side 23, to provide rigidity to the rear portion of platform 20.

A wall 27 (FIG. 8) projects downwardly from the underside of plate-like member 21, and perpendicular to said plate-like member. Wall 27 extends longitudinally between the first short side 22 and second short side 23. Another wall 34 projects downwardly from the underside of plate-like member 21, perpendicular to the said plate-like member, parallel to wall 27. Wall 34 extends longitudinally between the first short side 22 and second short side 23. Walls 27 and 34 are connected at the lower end by a rectangular base portion 33 (FIG. 8), adapted to be integrally formed with said walls. Base portion 33 extends longitudinally parallel to the plate-like member 21, between first short side 22 and second short side 23 to add additional rigidity to platform 20. Walls 27, 34 and base portion 33 define a U-shape configuration having its ends seated on support flanges 49 (FIG. 11). Said U-shape is formed integrally with the plate-like member 21 to achieve maximum rigidity for resisting bending moment stresses.

The edge of front long side 24 (FIG. 9) projects downwardly perpendicular to plate-like member 21 to form wall 28; said wall extends longitudinally between first short side 22 and second short side 23. Wall 30 projects downwardly from the underside of plate-like member 21, perpendicular to plate-like member 21, parallel to wall 28 and laterally spaced apart therefrom. Wall 30 extends longitudinally between the first short side 22 and second short side 23. Walls 28 and 30 are adapted to be integrally connected at the lower end by rectangular base portion 29 (FIG. 8). Base portion 29 extends longitudinally parallel to the plate-like member 21, between first short side 22 and second short side 23. Base portion 29 having a plurality of apertures 16 (FIG. 8) adapted for receiving fastening means (rivet) to connect fixedly platform 20 to side supports 40 and 50 (FIG. 7). The two ends of the U-shape configuration of walls 28 and 30 and base portion 29 are seated on and fasten to support flanges 48 (FIG. 11) of the side supports 40 and 50. The U-shape is formed integral with plate-like member 21 to add additional rigidity to the front portion of platform 20 whereon the majority of a user's weight is applied (FIG. 10).

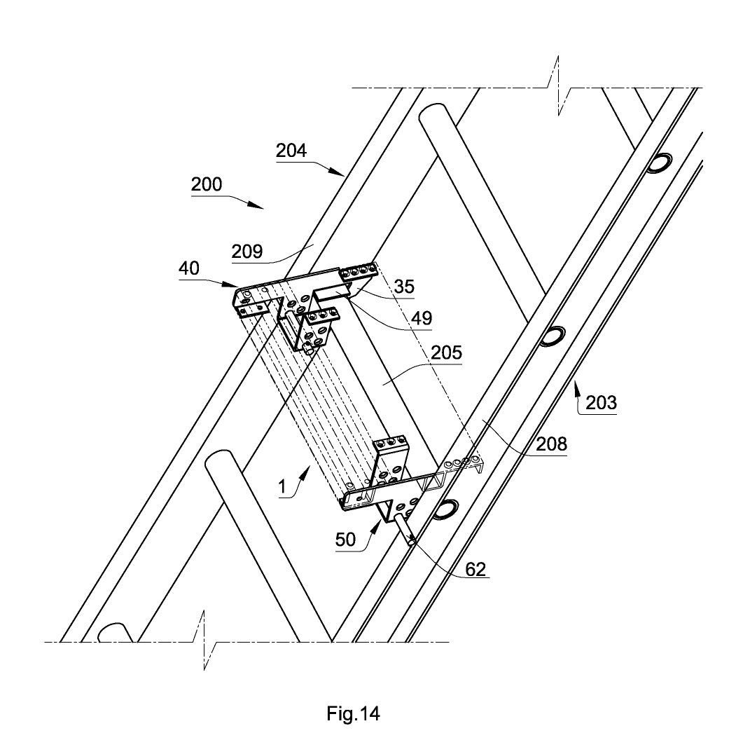

The pair of side supports 40 and 50, illustrated in FIGS. 11-14, is adapted for securing step 1 in working position, affording said step excellent stability and transferring a considerable amount of the applied load to the side rails 203 and 204, as it can be seen in FIG. 14. As shown in FIG. 11, side support 40 is a mirror image of side support 50 and functions similarly; however, side support 40 includes a slot 31 while side support 50 includes circular aperture 32.

Side support 40 is one single stamped/folded plate configuration that includes support arm 41, support flanges 46, 48, and 49, hook 35 and support leg 12. Support arm 41, having a front edge 42 (FIG. 12) extends downwardly perpendicular to the platform 20 plane, a rear edge 43 extends downwardly parallel to edge 42, an upper edge 44 being extended between edges 42 and 43 and flushed with the upper surface of platform 20, and a lower edge 45 extends between edges 42 and 43 parallel to edge 44.

The upper edge 44 has a straight bent adjacent to rear edge 43, being laterally extended toward opposite side support 50 perpendicular to support arm 41 to form support flange 46 having plurality of apertures 47 (FIG. 11) spaced longitudinally. Support flange 46 is fixedly connected to platform 20 by means of rivets received in apertures 47.

The lower edge 45 of support arm 41 has a pair of straight bents laterally extended toward opposite side support 50, and perpendicular to support arm 41 to form support flanges 48 and 49, which are spaced apart. Support flange 48 is adjacent to the front edge 42 and has a plurality of apertures 38 for receiving rivets therein. Support flange 49 is adjacent to the rear edge 43, and is adapted to be seated on rung 205 (FIG. 14). Support flange 48, which is riveted to platform 20, is configured to receive and support said platform cooperatively with flange 49 and support arm 41.

Adjacent to edge 43 (FIG. 12), the lower edge 45 projects downwardly in a form of hook 35, with an interior straight edge 36 extending downward and toward supporting rung 205. Edge 36 terminates with a curved edge 37 adapted to receive a rung having a circular cross section (FIG. 12). Edge 36 inclines with a selected angle so as to better achieve a contact area with a rear face of a rung with anon-circular section.

Side support 40 includes support leg 12 (FIG. 7) having support walls 61 and 64 and base portion 63. Support wall 61 projects from lower edge 45 downwardly perpendicular to platform 20 plane; support wall 61 formed integrally as a part of support arm 41, spaced apart from flanges 49 and 48. Support wall 61 has a plurality of apertures 39 (FIG. 12) that are adapted to slidably receive engaging pin 62 (FIG. 13). Apertures 39 are spaced apart with a selected distance to accommodate various depths of the side rail web. Support wall 61 has a lower end that bends toward the opposite side support 50 to form base portion 63, which extends in plane parallel to platform 20 plane and perpendicular to support wall 61. Support wall 64 (FIG. 11) is formed integrally with base portion 63 and extends parallel to support wall 61 and perpendicular to base portion 63. Support wall 64 has plurality of apertures 65 aligned with apertures 39 adapted to receive engaging pin 62 (FIG. 13). Support wall 64 terminates with a straight bent that extends parallel to platform 20 plane and perpendicular to support wall 64 to form support flange 66 (FIG. 13). Support flange 66 has a plurality of apertures 60 (FIG. 11) adapted for receiving rivets used to connect fixedly support flange 66 to plate-like member 21.

Support leg 12 has a configuration adapted to resist twisting that may occur in the side support when platform 20 becomes an under-working load. As shown in FIG. 7, support wall 64 abuts the U-shape configuration of walls 27, 34 and base portion 33; this arrangement in cooperation with the support flange 66 allow side supports 40 and 50 to resist the torsion force induced from a moment generated by engaging pins 62.

The support leg 12 receives engaging pin 62 (FIG. 13), which slides reciprocatively through the pair of aligned apertures 39 and 65. Engaging pin 62 is configured to engage surfaces 208 and 209 (FIG. 14) of side rails 203 and 204, respectively (FIG. 1) to step 1. Engaging pin 62 is provided with a pair of cotter pins, snap pins or like stop device 67, one at each end to prevent dislodgement. The combination of engaging pin member 62 and support leg 12 forms an adjuster configuration to accommodate various web depths and various positioning angles of side rails, so as to maintain platform 20 in a substantially horizontal position when in use.

A continuous slidable rod 13 (FIG. 21) can be used as an alternative to the engaging pins 62. By using such a rod, the torsion force applied on the support leg can be reduced significantly, as the opposite end of the rod is not free, but is engaged to the opposite support leg. Another feature makes rod 13 unique from other inventions; the bending moment span which extends between opposing support walls 64 is shorter than the platform 20, which means that lower bending moment stress is being applied on said rod. Rod 13 is provided with a pair of cotter pins 14 to prevent dislodgement.

Referring to FIG. 12, there is illustrated a system comprising a step 1 and mounting means 10 to mount step 1 to a side rail of a ladder 200 when not in use.

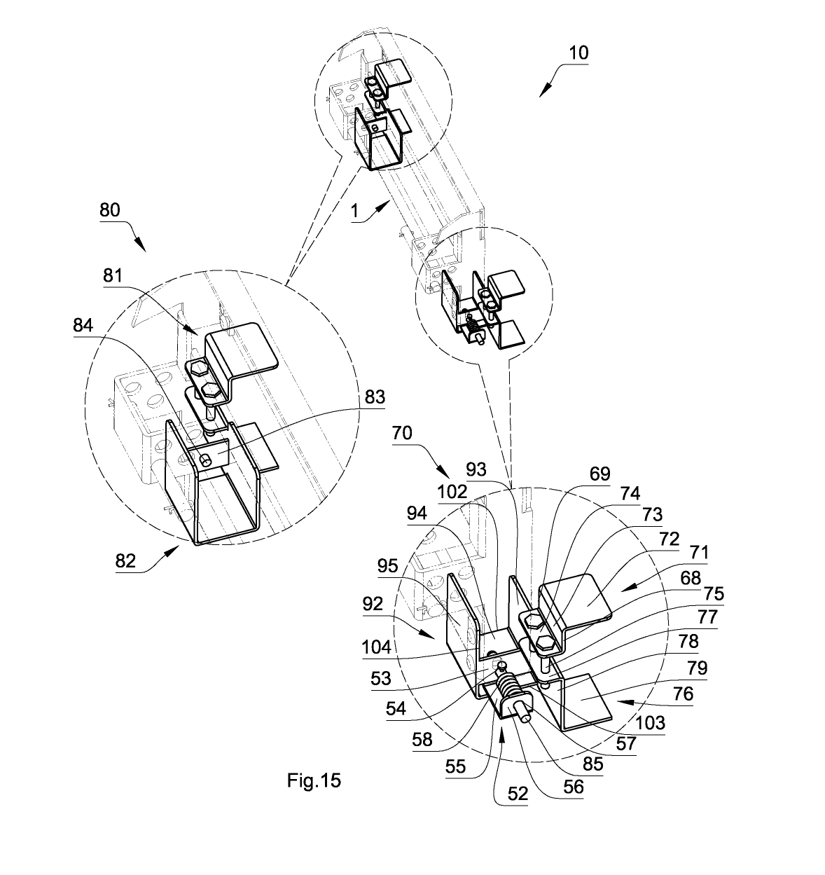

FIGS. 15-19 show mounting means 10, which includes first mounting bracket 70 and second mounting bracket 80, which are provided to receive and attach step 1 to a ladder body when not in use.

Mounting brackets 70 and 80 include a connecting means for attaching said mounting brackets to a ladder body, a step-receiving means to secure step 1 to the mounting means 10, and a step-locking means adapted for locking step 1 firmly to the mounting bracket for preventing accidental dislodgement.

As seen in FIG. 12, side support 40 includes slot 31, located adjacent to front edge 42 adapted to receive the slidable lock pin 85 (FIG. 15), which is used to engage step 1 to the mounting bracket 70. In FIG. 11, side support 50 includes aperture 32 located adjacent to front edge 42 adapted to receive a fixed lock pin 84 (FIG. 15) which is used to lock step 1 to the mounting bracket 80.

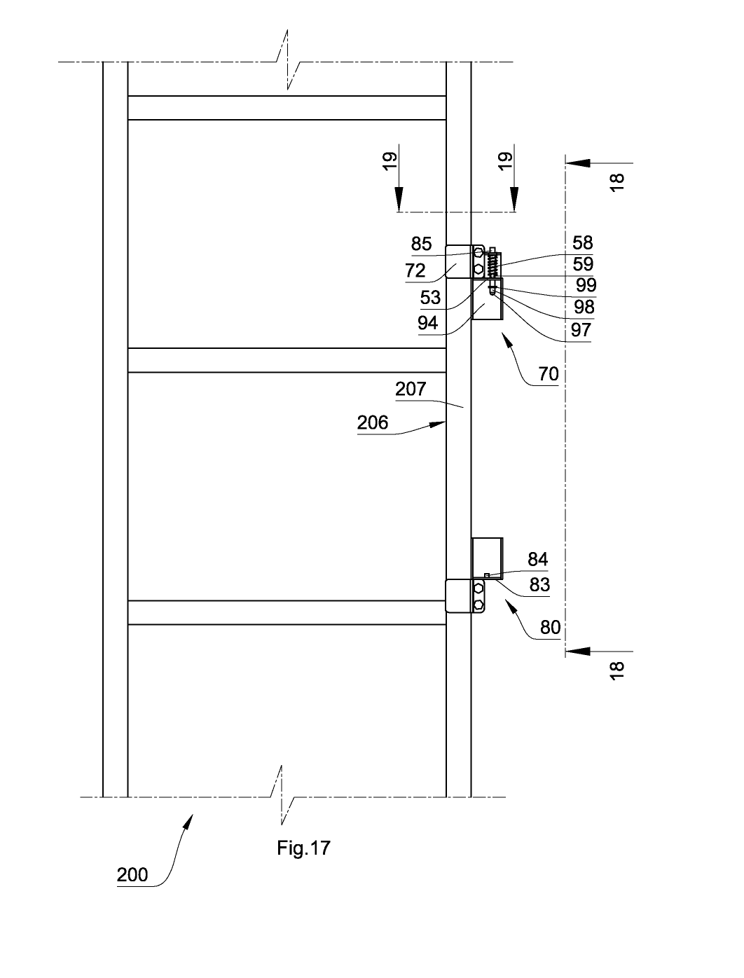

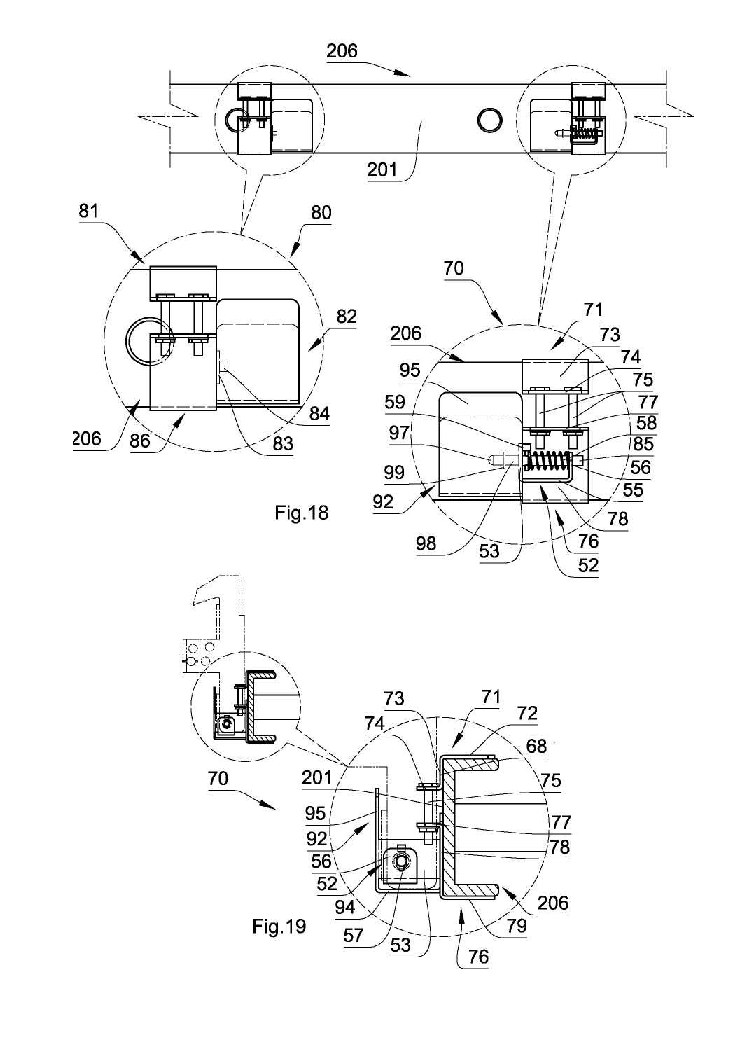

The first mounting bracket 70 includes connecting means comprising connecting upper-part 71 and connecting lower-part 76 (FIG. 15). Connecting upper-part 71 is a single metal plate that includes wall 73, to abut exterior surface 201 of side rail 206 (FIG. 18) and has edges 68 and 69 (FIG. 15). When mounted, the connecting upper-part 71 extends perpendicular to the ladder plane. Wall 73 has a straight bent that extends between edges 68 and 69 (FIG. 15) in plane parallel to the ladder plane and perpendicular to wall 73 to form flange 72 which is adapted to abut front face 207 of side rail 206 (FIG. 17). As illustrated in FIG. 19, wall 73 has a connecting flange 74 that extends laterally between edges 68 and 69 in a direction away from side rail 206. Connecting flange 74 lays in plane perpendicular to wall 73 plane, includes pair of apertures for receiving fasteners 75. Connecting upper-part 81 (FIG. 15) in mounting bracket-part 80 is a mirror image of mounting bracket-part 71 and functions similarly.

As shown in FIG. 18, connecting lower-part 76 includes wall 78, which abuts the exterior surface 201 of side rail 206 (FIG. 18); wall 78 extends in plane perpendicular to the ladder plane. Wall 78 lower end has a straight bent that extends in plane parallel to the ladder plane and perpendicular to the wall 78 plane to form flange 79 (FIG. 19) which abuts side rail 206 rear surface opposite to surface 207. As illustrated in FIG. 19, wall 78 upper end has a straight bent adapted to form connecting flange 77 extends in a direction away from side rail 206 and lays in plane parallel to the ladder plane and perpendicular to wall 78 plane; connecting flange 77 includes a pair of apertures for receiving fasteners 75. Connecting lower-part 86 (FIG. 18) in the mounting bracket-part 80 is a mirror image of connecting lower-part 76, and functions similarly. Connecting upper-part 71 and connecting lower-part 76 form clamp jaws configuration adapted to firmly connect the first mounting bracket 70 to side rail 206 by using a combination of bolts, washers and nuts, as seen in FIG. 18.

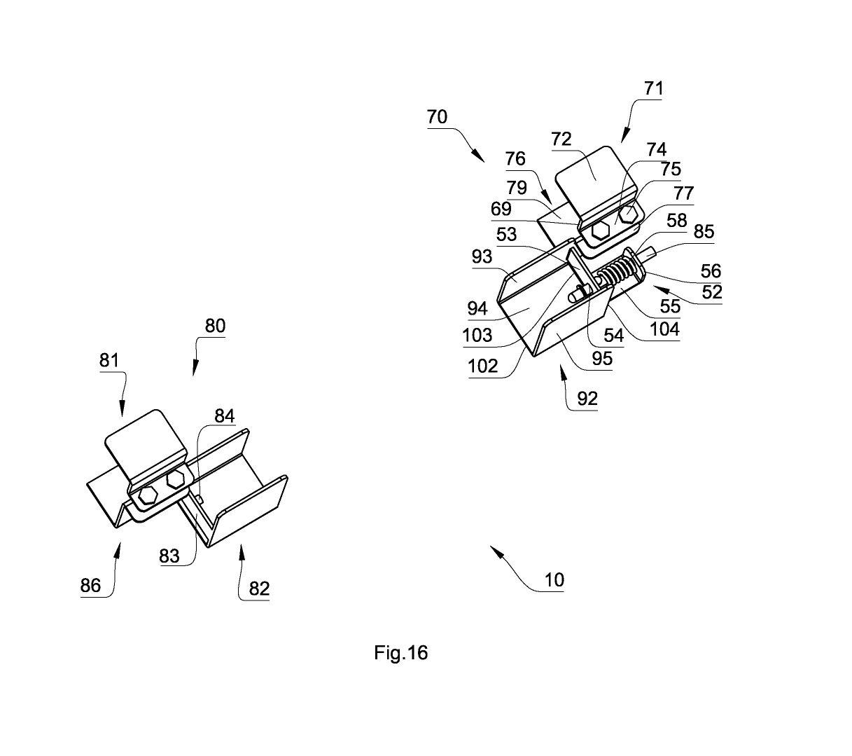

As illustrated in FIG. 16, first mounting bracket 70 includes a step-receiving-part 92 having a base portion 94 that extends in plane parallel to the ladder plane and has edges 102 and 103 (FIG. 16). A pair of paralleled side walls 93 and 95, projects upwardly from the base portion 94, perpendicular to the ladder plane. Side wall 93 is formed integrally with wall 78 (FIG. 18), such that the rear face abuts the side rail exterior face 201. Side walls 93 and 95 extend between edges 102 and 103 (FIG. 16) and perpendicular to base portion 94. The configuration of side walls 93 and 95 and base portion 94 forms a U-shape configuration which defines a space adapted to receive part of step 1. The step-receiving-part 82 (FIG. 16) in second mounting bracket 80, is a mirror image of the step-receiving-part 92 in first mounting bracket 70 and functions similarly. Step-receiving-part 92 is adapted to receive part of step 1, the part that includes slot 31; whereas step-receiving-part 82 in mounting bracket-part 80 is adapted to receive the step part that includes aperture 32.

As best seen in FIGS. 15 and 16, first mounting bracket 70 includes step-locking-part 52 having a straight plate member 53 formed integrally with side wall 95 and extending from edge 104, perpendicular to both side walls 93 and 95. The opposite end of plate member 53 adjacent to side wall 93 is spot welded to said wall 93 (FIG. 16). Plate member 53 has aperture 54 (FIG. 16) aligned with aperture 57 (FIG. 19) and slot 31 (FIG. 12); the two said apertures are adapted to slidably receive lock pin 85 (FIG. 15) therein. Plate member 53 has a lower edge that bends outwardly from the U-shape configuration in plane parallel to the ladder plane and perpendicular to plate member 53 plane to form base plate 55 (FIG. 18), adjacent to side wall 95. Base plate 55 has a straight bent that extends upwardly parallel to plate member 53 and perpendicular to the ladder plane to form wall 56, having an aperture 57 (FIG. 15) aliened with aperture 54 and slot 31 (FIG. 12). Step-locking-part 52 has a slidable lock pin 85 that extends through aligned apertures 54 and 57; lock pin 85 extends partially through compression spring 58, and has a rounded end 97 (FIG. 18) to guide penetrating portion 98 into slot 31 to engage step 1 to the first mounting bracket 70. As illustrated in FIGS. 17 and 18, washer-like member 99 is formed integrally with lock pin 85 to form an obstacle against side support 40 (FIG. 11). Lock pin 85 includes stop pin 59 (FIG. 18) adapted to form an obstacle against spring 58. Spring 58 presses against wall 56 and stop pin 59 urging lock pin 85 toward step 1. In the mounting process, when penetrating portion 98 is engaged with slot 31, side support 40 pushes washer-like member 99 and lock pin 85 backwardly, to apply additional compression force on spring 58. As step 1 is completely mounted in place, washer-like member 99 applies force originally generated by spring 58 on side support 40 (FIG. 11) to prevent step 1 from accidental dislodgement. Spring 58 is elastically under compression when step 1 is not mounted, and elastically compressed to the maximum when said step is being grasped by the mounting means 10.

As shown in FIG. 16, plate member 83 in second mounting bracket 80 is a mirror image of plate member 53, having fixed lock pin 84 being welded at the midway; said lock pin is adapted to be engaged with aperture 32 (FIG. 11), to secure step 1 to the second mounting bracket 80.

As an alternative to the mounting means 10, a step-holder in a form of an enclosure such as a bag (not illustrated herein), can be used to attach step 1 to a ladder body. The step-holder is formed of a combination of a metal, leather and/or a fabric material or the like. A metal portion is adapted to firmly attach a step-receiving means to a ladder side rail. A fabric portion may forma space adapted to receive the step or part of it therein. A conventional locking means can be used to lock the step in place to avoid dislodgement.

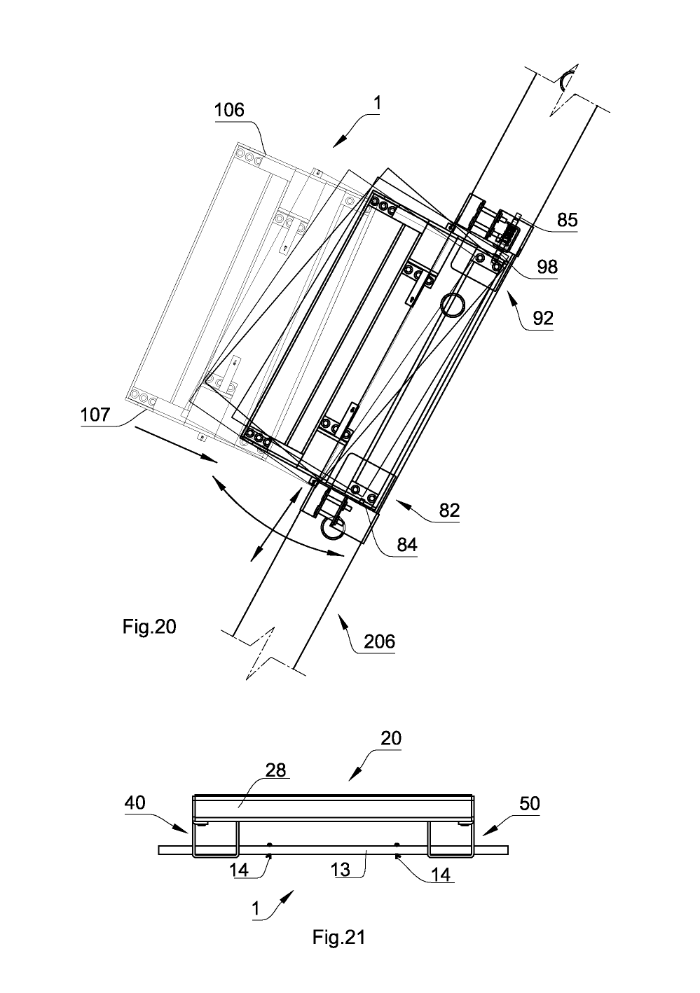

In order to secure step 1 to the mounting means 10, a user must align the long side of step 1 with a longitudinal axis defined by the mounting brackets. The user has to position said step on an angle with the ladder plane such that the front portion of step side 106 is being received by the step-receiving-part 92, as shown in FIG. 20. The portion adjacent to slot 31 (FIG. 12) is used to push the slidable lock pin 85 backwardly against spring 58 force. A first click is a sign of snapping slot 31 penetrating portion 98 (FIG. 18). While lock pin 85 is being pushed all the way back, the opposing side 107 of step 1 is rotated toward step-receiving-part 82, until aperture 32 is brought into engagement with the fixed pin 84; a second click is a sign of securing the step to the mounting bracket 10.

In operation, assuming that the abutment means (pins 62 or rod 13) of the removable ladder step 1 is already adjusted to accommodate the existing ladder side rails, the user positions the ladder in a suitable angle corresponding to the step's horizontal plane. As a user climbs up to the targeted location, the user pushes and holds the step by using one hand in a direction parallel to the side rail axis and against spring 58 to disengage the fixed lock pin 84 (FIG. 15). While the step is being held in position, the opposing side 107 (FIG. 20) is rotated away from the step receiving-part 82, until fully dislodged from the mounting bracket-part 80. Disengaging penetrating portion 98 is achieved by moving the step downwardly and parallel to the side rail axis. The final step consists of pulling step 1 outwardly from the mounting bracket-part 70 to be mounted later on onto the required supporting rung in the required elevation. Upon reaching the desired height, the user mounts step 1 to the supporting rung 205 so that hooks 35 (FIG. 14) are brought into engagement with the rear side surface of said rung, as seen in FIG. 12. To secure step 1 to the side rails 203 and 204, engaging pins 62 are pushed all the way out toward said side rails to abut surfaces 208 and 209 (FIG. 14).

In operative position, step 1 is supported by rung 205 and side rails 203 and 204. Engaging pins 62 lock step 1 to said side rails in cooperation with hooks 35 to prevent any movement. When the step is loaded by a user standing on platform 20, the applied load is supported simultaneously by the rung 205 and side rails 203 and 204. The inclination in the side rails induces a force having a horizontal component that pulls the step in a direction away from the ladder support. The said horizontal force is resisted by hooks 35, which are adapted to anchor step 1 to rung 205. This arrangement enables the step to efficiently resist the horizontal and vertical forces, thereby a user is provided with a maximum safety and stability.

To adjust the step in a horizontal plane relative to a selected inclination angle of the side rails, a user disengages the slidable engaging pins 62 (FIG. 13) from side supports 40 and 50. The user then adjusts the step in a horizontal position relative to said angle, and reinserts the slidable engaging pins 62 through the apertures closest to the side rail surfaces 208 and 209 (FIG. 14), and reengages stop devices (cotter pins or snap pins) 67 (FIG. 6).

The above described invention may be subject to various changes, additions, alterations or modifications that can be made without departing from the scope and spirit of the invention as defined in the appended claims. Thus, for example, supporting pins 62 can be replaced by one continuous rod 13, stiffeners can be added to the connecting upper-parts and connecting lower-parts, to apply maximum clamping force on the side rail.

I claim:

1. A ladder step removably mountable for providing additional foot support to a rung ladder having first and second side rails and rungs extending therebetween, the ladder step comprising:
a platform provided with first and second side supports at opposite sides thereof, the first side support having a first stop member at a first end thereof adapted to engage a first end of a rung, and an abutment means projecting outwardly from a second end of said first side support to abut on a frontal face of said first side rail member; the second side support having a second stop member at a first end thereof adapted to engage a second end of the rung and an abutment means projecting outwardly from a second end of said second side support to abut on a frontal face of said second side rail, a distance between the first and the second stop members being shorter than the rung;
whereby the ladder step is mountable to the ladder in a working position by engaging the stop members about the rung and causing the abutment means to abut on the front faces of the first and second side rails respectively.

2. A removable ladder step as defined in claim 1, further comprising at least one aperture provided in said side supports and adapted to co-operate with mounting means, whereby said removable ladder step is attachable to a ladder body by said mounting means when the removable ladder step is not in use.

3. A removable ladder step as defined in claim 1, wherein said platform comprises:
a horizontal plate-like member having opposing short sides and opposing long sides; and
a plurality of walls projecting from said plate-like member downwardly therefrom; said walls extending longitudinally between said short sides of said plate-like member and spaced apart laterally, the walls being configured for providing structural rigidity.

4. A removable ladder step as defined in claim 3, wherein said platform further comprises at least one base portion being integrally formed with said walls, said base portion extending longitudinally between said opposing short sides of said plate-like member to add additional rigidity to the platform.

5. A removable ladder step as defined in claim 1, wherein each of said first and second side supports comprises a support arm, and said stop member defines a hook configuration that projects from a lower side of said support arm; said hook configuration being adapted to engage the rung to resist a generally horizontal force acting in a direction toward said second end of said side support.

6. A removable ladder step as defined in claim 1, wherein each of said first and second side supports further comprises a support leg projecting downwardly at the second end below the platform, the support leg including a first support wall having a plurality of apertures being configured to selectively receive an abutment means therein.

7. A removable ladder step as defined in claim 6, wherein said support leg further includes a second support wall opposite and substantially parallel to said first support wall;
said second support wall projecting upward from a base portion formed integrally with, and perpendicular to, said first support wall; said second support wall including at least one support flange and a plurality of apertures which are correspondingly located and aligned with said apertures in said first support wall to form aligned pairs of apertures being configured to receive at least one longitudinal abutment means being slidably insertable therethrough.

8. A removable ladder step as defined in claim 1, wherein said abutment means comprises an engaging pin being configured to reciprocatively slide through aligned apertures provided in said side support; the engaging pin having a first end that extends substantially outwardly from the side support to abut a side rail, and is provided with retaining means at the first end and at a second end thereof to limit a travel and prevent dislodgement from the support.

9. A removable ladder step as defined in claim 1, wherein said abutment means comprises a continuous slidable rod that extends through aligned apertures provided in said side supports, whereby an end of the rod extends substantially outwardly from each side support to engage the adjacent side rail, the rod having retaining means to prevent dislodgment.

10. A removable ladder step as defined in claim 1, wherein said removable ladder step is constructed of material selected from the group consisting of metal, plastic, fiberglass, wood and any combination thereof.

11. A ladder step system mountable to a rung ladder having rungs and side rails defining a ladder body, the system comprising:
A removable ladder step for providing additional foot support to the rung ladder and ladder step mounting means attachable to a part of the ladder body and adapted to removably attach said ladder step thereto for storing the ladder step when not in use.

12. A ladder step system as defined in claim 11, wherein said removable step comprises first and second side supports, the first side support having a slot and the second side support having an aperture, the slot and aperture being configured for receiving locking means of the mounting means to removably engage said removable ladder step to said mounting means.

13. A ladder step system as defined in claim 11, wherein said mounting means comprises mounting brackets being fixedly attached to the ladder body; said mounting brackets being configured for receiving and attaching said removable ladder step to the ladder body, when not in use.

14. A ladder step system as defined in claim 11, wherein said mounting means comprises first and second mounting brackets, each bracket having:
a connecting means for fixedly attaching said mounting bracket to the ladder body;
a step-receiving means being configured for forming a space adapted for receiving at least a portion of the removable ladder step therein; and
a step-locking means to lock said removable ladder step to said step-receiving means so that dislodgement of the removable ladder step can be prevented.

15. A ladder step system as defined in claim 14, wherein said connecting means is fixedly attachable to the ladder body and connected to said step-receiving means; said connecting means including a plurality of portions which are angled with respect to one another, and configured to abut a side rail surface for attaching firmly said mounting bracket to the ladder body.

16. A removable ladder step as defined in claim 14, wherein said step-receiving means is connected firmly to said connecting means; said step-receiving means including a base portion connected to a plurality of side walls that extend perpendicular to a ladder plane; at least one of said side walls abutting the side rail surface; said base portion and said side walls defining a space being adapted for receiving at least a portion of the removable ladder step;
said step-receiving means having at least one side being opened.

17. A ladder step system as defined in claim 14, wherein the step-locking means of the first mounting bracket comprises a slidable lock pin configured to reciprocatively slide through aligned apertures defined in opposing walls; said slidable lock pin being urged by a resilient compression means and being receiveable in a slot of a first side support of the removable ladder step to engage said ladder step to said first mounting bracket.

18. A removable ladder step system as defined in claim 17, wherein the step-locking means of the second mounting bracket further comprises a pin member fixedly attached to the side wall of said step-receiving means; said pin member being receivable in an aperture of a second side support of the removable ladder step to engage said ladder step to said second mounting bracket.

19. A ladder step system as defined in claim 11, wherein said mounting means comprises a step-holder enclosure being firmly attachable to the ladder body by connecting means; said step-holder enclosure comprising a bottom being connected to a plurality of side panels wherein at least one of said side panels abuts a side rail surface; said bottom and said side panels defining a space being usable for receiving and holding at least part of said removable ladder step when not in use; wherein said space has at least one open side; said step-holder further comprising a locking means for retaining and preventing said removable ladder step from being dislodged.
